(19) United States
(12) Patent Application Publication
(10) Pub. No.: US 2018/0294957 A1
(43) Pub. Date: Oct. 11, 2018

(54) System for Recording Ownership of Digital Works and Providing Backup Copies

(71) Applicant: Walmart Apollo, LLC, Bentonville, AR (US)

(72) Inventors: John Jeremiah O'Brien, Farmington, AR (US); Brian Gerard McHale, Oldham (GB); Robert Cantrell, Herdon, VA (US); Donald Ray High, Noel, MO (US); Bruce W. Wilkinson, Rogers, AR (US); Todd Davenport Mattingly, Bentonville, AR (US)

(21) Appl. No.: 15/944,989

(22) Filed: Apr. 4, 2018

Related U.S. Application Data
(60) Provisional application No. 62/482,908, filed on Apr. 7, 2017.

(51) Int. Cl. H04L 9/06; G06F 21/10

(52) U.S. Cl. CPC H04L 9/0643; G06F 21/105

(57) ABSTRACT

Exemplary embodiments of the present disclosure are related to a secure storage system for maintaining ownership rights of digital works. Embodiments of the secure storage system can include the user terminal device, one or more non-transitory computer-readable media, and a computing system.

### CROSS-REFERENCE TO RELATED PATENT APPLICATIONS

This application claims priority to U.S. Provisional Application No. 62/482,908 filed on Apr. 7, 2017, the content of which is hereby incorporated by reference in its entirety.

### BACKGROUND

Currently, digital works can be easily copied. In fact, copying remains a problem if the document can be displayed at all since a displayed document can be photographed. As tools for accessing and stealing works become more sophisticated, tools to prevent or discourage theft of works either by blocking theft or helping enforcers track the source become more important. A system for recording ownership of digital works and providing backup copies is needed for the users that have purchased digital works and then have a computer crash or other loss of the digital works.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates an exemplary secure storage system for maintaining ownership rights of digital works in accordance with an exemplary embodiment of the present disclosure;

FIG. 2 comprises an illustration of blocks as configured in accordance with various embodiments of the present disclosure;

FIG. 3 comprises an illustration of transactions configured in accordance with various embodiments of the present disclosure;

FIG. 4 comprises a flow diagram in accordance with various embodiments of the present disclosure;

FIG. 5 comprises a process diagram as configured in accordance with various embodiments of the present disclosure;

FIG. 6 comprise a system diagram configured in accordance with various embodiments of the present disclosure;

FIG. 7 illustrates a block diagram an exemplary computing device in accordance with various embodiments of the present disclosure; and

FIG. 8 is a flowchart illustrating a process implemented by the blockchain ownership storage system.

### DETAILED DESCRIPTION

Described in detail herein is a system for recording ownership of digital works and providing backup copies of the digital works. A blockchain system can be used to track a single unit of a digital work, such as music, private written records, manuscripts, lab notebooks, photographs, video, computer code, 3D printing templates, etc. For example, if a user purchases a song or book, the song or book is given a blockchain code unique to that copy. Every time that copy of the song or book is copied or transferred, the copy can receive a new blockchain code and new block can be generated. Therefore, the blockchain system can trace the copied material to its source. It can also flag that a copy is illegitimate and prevent an owner from transferring the digital work more than once. The blockchain ensures the integrity of the digital work as one, single unit within the owner's account.

Exemplary embodiments of the blockchain system can also provide a mechanism by which users can sell digital work in the same way they sell a physical work, such as a used book or CD, and further, the coding can include a mechanism whereby digital work can be resold by users once and transferred from their account, perhaps with a royalty being paid to the artist or owner. Some coding may be added when triggered by a blockchain action, such as royalty payment. Exemplary embodiments of the blockchain system can allow a digital work to be created as a single unit, like a physical copy, that can be tracked, transferred singly, monitored, and duplicated with proper permissions. When the digital work is duplicated with proper permissions, a new digital IP record can be “mined” into the system that is traceable to its source but otherwise gets its own blockchain string. The digital IP blockchain can be traceable back to the single common ancestor, even if the digital work for which the blockchain is created evolves.

In another example, the blockchain system can be used in lab notebooks and other digital works/records that include confidential information where the timing and integrity of the creation is important, and where the document at that point must not evolve, for example, change without creating a new timestamp and record fingerprint. Blockchain events could be triggered each time the specific digital work, for example, a lab notebook or other confidential document, is accessed, copied, added to, read, and so on. This could be done to a granular level, and algorithms can be added that indicate the potential for lost IP, such as digital copying to personal drives, plagiarism by cut and paste or type copying, or even scroll-and-stop patterns that could indicate someone is photographing content off a computer screen. When such activity is detected, the digital work can be automatically closed pending verification of legitimate use.

To even access such digital works, users can be required to exchange hashtags keys so that the holder of the digital work exchanges the right or value to view and handle sensitive digital works with a requester, i.e., an individual with the authority to see the confidential digital works. So even if a digital work was spirited away outside a firewall of the holder, for example, the digital work cannot be accessed without the proper hashtags key. It is possible that any act involving a digital work (e.g., confidential document) would automatically change the key, transparent to those with legitimate access but locking out illegitimate access. A legitimate user of the digital work can receive the updated key instantly, but the illegitimate receiver, even if possessing the current key, would be locked out without receiving the updated key. Further, the hashtag key could reside in a device that is physically separated from the repository such that the physical device must be mechanically or electrically connected to the repository to work, countering remote hacking and making it easier to detect insider hacking.

The owner of the digital work, for example, a photographer, could change the settings on his/her artwork to allow sharing while still retaining the legal copyright. Depending on the content, blockchaining could be automatic, such as in the creation of confidential accounting records, or it could be added on, such as to music that the creator does not want shared without compensation.

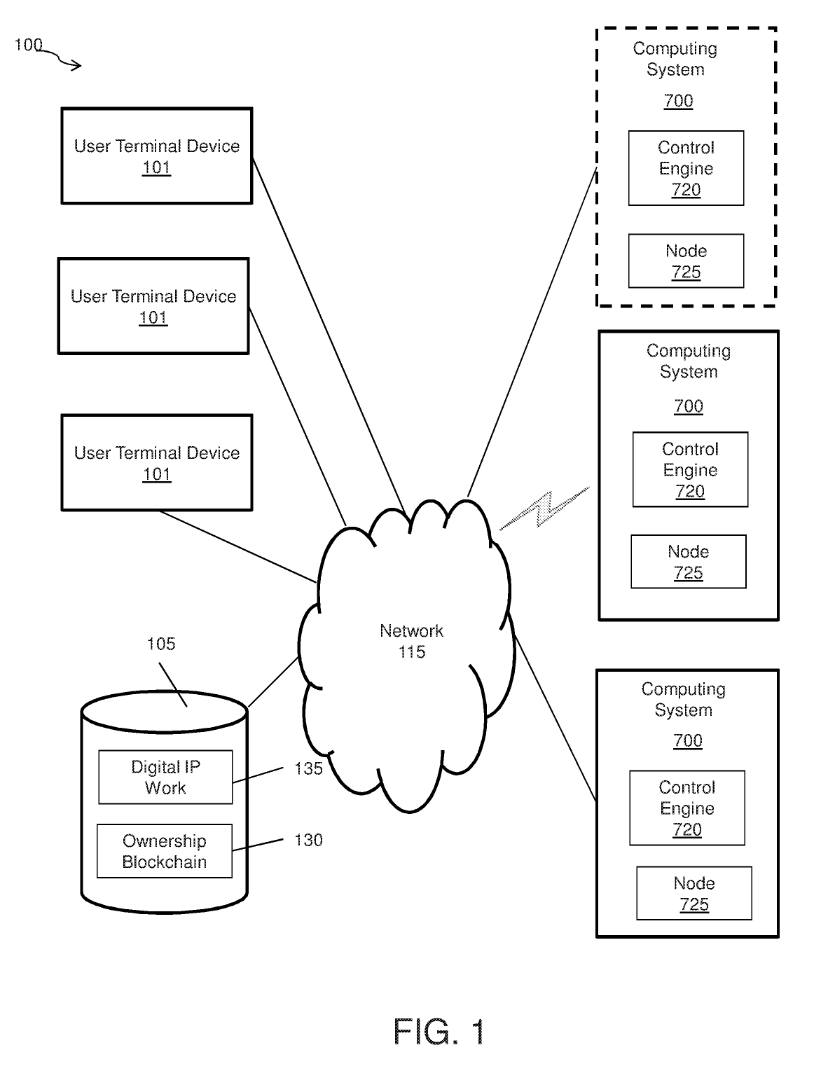

FIG. 1 illustrates an exemplary system for recording ownership of digital works and providing backup copies in accordance with an exemplary embodiment. The blockchain ownership recording system 100 can include one or more databases 105, one or more computing systems 700, and one or more user terminal devices 101. The computing system 700 can be in communication with the databases 105, and the user terminal devices 101 via a communications network 115. The computing system 700 can implement at least one instance of a control engine 720. The control engine 720 can be an executable application executed on the computing system 700. The control engine 720 can execute processes of the blockchain ownership recording system 100 as described herein. The computing system can include one or more nodes 725. Each of the one or more nodes 725 can store a copy of a blockchain record and/or a shared ledger. The one or more nodes 725 can be configured to update the blocks in the blockchain record.

In an example embodiment, one or more portions of the communications network 115 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

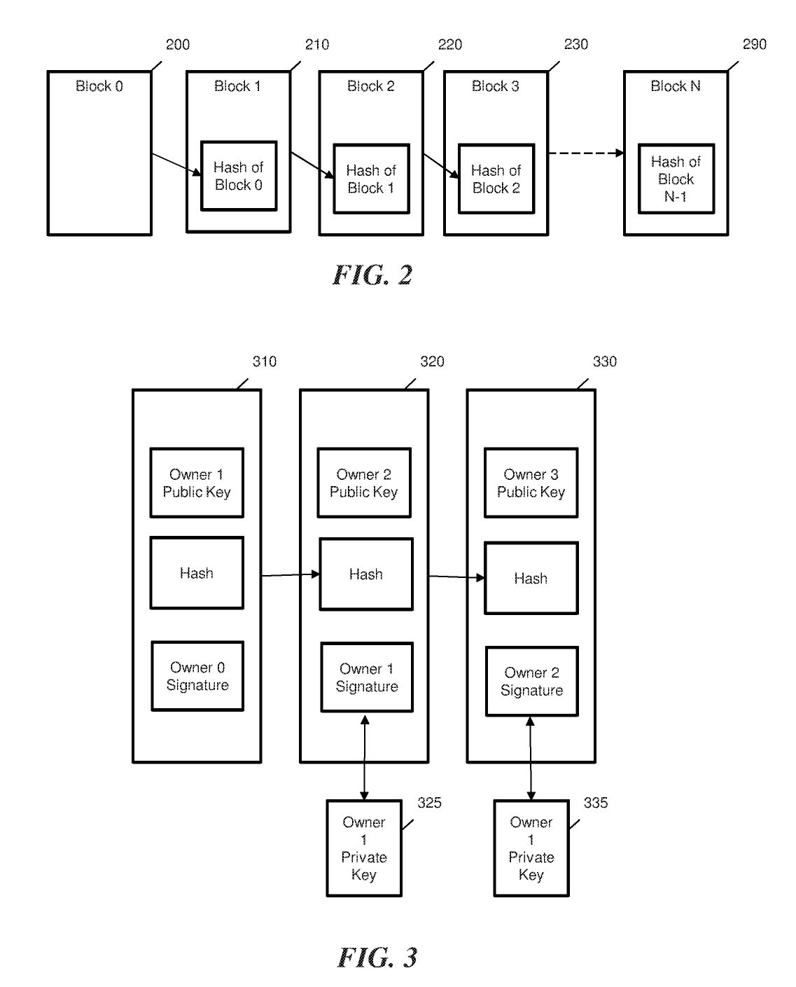

The computing system 700 includes one or more computers or processors configured to communicate with the databases 105 and the devices 101. The computing system 700 hosts one or more applications configured to interact with one or more components of the blockchain ownership storage system. The databases 105 may store information/data, as described herein. For example, the databases 105 can include a digital work database 135 and an ownership blockchain database 130. The digital work database 135 can include information associated with the digital work and a representation of digital work. The ownership blockchain database 130 can be embodied as a blockchain storage system as described in FIGS. 2-7, configured to store a blockchain record or a shared ledger. The blockchain storage system can store digital ownership associated with a digital work. The databases 105 and the computing system 700 can be located at one or more geographically distributed locations from each other. Alternatively, the databases 105 can be included within first computing system 700.

In exemplary embodiments, a user can generate a request from the terminal device 101 to obtain a digital work, for example, to access/view or recover the digital work. The computing system 700 can execute the control engine 720 in response to receiving the request. The control engine 720 can store the request in the digital work database 135, and determine whether the request to obtain the digital work can be authorized according to restrictions associated with the digital work (e.g., transfer restrictions, access/viewing restrictions, copying restrictions, recovery restrictions). When the request is authorized, the control engine can transfer a copy/instance of the digital work to the terminal device 101, or any other designated device, display an instance of the digital work, and/or generate an ownership file for the transferred or displayed copy/instance of the digital work.

The ownership file can be stored in the ownership blockchain database 130 using the blockchain storage system as described in FIGS. 2-7. For example, the node 725 can generate a block in the ownership blockchain database 130. The block can store the digital ownership file. A private and public key can be associated with the block storing the digital ownership file. A user can grant access to another user by providing the public and private key to the block storing the digital ownership file. The other user can attempt to access the digital ownership file using the public and private key. The node 725 can verify the public and private key of the block and provide access to the digital ownership file in response to verification. The node 725 can generate a subsequent block including transaction records of the other user successfully gaining access to the digital ownership file. A private key and public key associated to the subsequent block can be included in the subsequent block. The user who is the owner of the digital ownership file, can provide access to the block with the digital ownership file. In the event, an attempt is made to access the digital ownership file with an incorrect public and/or private key, the node 725 can restrict access to the digital ownership file. The node 725 can also generate a new block including transaction records associated with the failed attempt at accessing the digital ownership file.

Each new block created associated with accessing the digital ownership file can include a hash key associated with the previous block to form a sequential chain of blocks where each block (except the root/genesis block) includes a hash key of a previous block in the chain. For example, in the event the block containing the digital ownership file is accessed, and a block is generated including transaction records associated the granted access. The new block can include a hash key of the block containing the digital ownership file. Side chains can also be created. For example, in the event there is a failed attempt to access the block containing the digital ownership file and the block is generated including transaction records associated with the failed access, the newly generated block can include a hash key of the block containing the digital ownership. However, the newly generated block may not include a hash key of the block including transaction records associated with the granted access to the block containing the digital ownership file. Accordingly, the block containing the digital ownership file can be linked in two different chains.

In the event a user is able to access the block with the digital ownership file, the user can transmit a request to transfer the digital work associated with the digital ownership file to another user. The control engine 720 can verify the digital ownership file and query the digital work database 135 to retrieve the representation of the digital work and the information associated with the digital work. Then the control engine 720 can transfer another copy of the digital work to another user.

Descriptions of some embodiments of blockchain technology are provided with reference to FIG. 2-7 herein. In some embodiments of the invention described above, blockchain technology may be utilized to record transactions of ownership. One or more of the user terminal device described herein may comprise a node in a distributed blockchain system storing a copy of the blockchain record. Updates to the blockchain may comprise transfer of ownership and one or more nodes on the system may be configured to incorporate one or more updates into blocks to add to the distributed database.

Distributed database and shared ledger database generally refer to methods of peer-to-peer record keeping and authentication in which records are kept at multiple nodes in the peer-to-peer network instead of kept at a trusted party. A blockchain may generally refer to a distributed database that maintains a growing list of records in which each block contains a hash of some or all previous records in the chain to secure the record from tampering and unauthorized revision. A hash generally refers to a derivation of original data. In some embodiments, the hash in a block of a blockchain may comprise a cryptographic hash that is difficult to reverse and/or a hash table. Blocks in a blockchain may further be secured by a system involving one or more of a distributed timestamp server, cryptography, public/private key authentication and encryption, proof standard (e.g. proof-of-work, proof-of-stake, proof-of-space), and/or other security, consensus, and incentive features. In some embodiments, a block in a blockchain may comprise one or more of a data hash of the previous block, a timestamp, a cryptographic nonce, a proof standard, and a data descriptor to support the security and/or incentive features of the system.

In some embodiments, a blockchain system comprises a distributed timestamp server comprising a plurality of nodes configured to generate computational proof of record integrity and the chronological order of its use for content, trade, and/or as a currency of exchange through a peer-to-peer network. In some embodiments, when a blockchain is updated, a node in the distributed timestamp server system takes a hash of a block of items to be timestamped and broadcasts the hash to other nodes on the peer-to-peer network. The timestamp in the block serves to prove that the data existed at the time in order to get into the hash. In some embodiments, each block includes the previous timestamp in its hash, forming a chain, with each additional block reinforcing the ones before it. In some embodiments, the network of timestamp server nodes performs the following steps to add a block to a chain: 1) new activities are broadcasted to all nodes, 2) each node collects new activities into a block, 3) each node works on finding a difficult proof-of-work for its block, 4) when a node finds a proof-of-work, it broadcasts the block to all nodes, 5) nodes accept the block only if activities are authorized, and 6) nodes express their acceptance of the block by working on creating the next block in the chain, using the hash of the accepted block as the previous hash. In some embodiments, nodes may be configured to consider the longest chain to be the correct one and work on extending it.

Now referring to FIG. 2, an illustration of a blockchain according to some embodiments is shown. In some embodiments, a blockchain comprises a hash chain or a hash tree in which each block added in the chain contains a hash of the previous block. In FIG. 2, block 0 200 represents a genesis block of the chain that includes the digital ownership file for a digital work. Block 1 210 contains a hash of block 0 200, block 2 220 contains a hash of block 1 210, block 3 230 contains a hash of block 2 220, and so forth. Continuing down the chain, block N contains a hash of block N−1. In some embodiments, the hash may comprise the header of each block. Each block added to the blockchain subsequent to the genesis block can be generated in response to a user requesting the digital work associated with the digital ownership file and can include a response to the request and/or the digital ownership file. Once a chain is formed, modifying or tampering with a block in the chain would cause detectable disparities between the blocks. For example, if block 1 is modified after being formed, block 1 would no longer match the hash of block 1 in block 2. If the hash of block 1 in block 2 is also modified in an attempt to cover up the change in block 1, block 2 would not then match with the hash of block 2 in block 3. In some embodiments, a proof standard (e.g. proof-of-work, proof-of-stake, proof-of-space, etc.) may be required by the system when a block is formed to increase the cost of generating or changing a block that could be authenticated by the consensus rules of the distributed system, making the tampering of records stored in a blockchain computationally costly and essentially impractical. In some embodiments, a blockchain may comprise a hash chain stored on multiple nodes as a distributed database and/or a shared ledger, such that modifications to any one copy of the chain would be detectable when the system attempts to achieve consensus prior to adding a new block to the chain. In some embodiments, a block may generally contain any type of data and record. In some embodiments, each block may comprise a plurality of ownership records associated with the activities to the digital work, such as creating legitimate copies of the digital work, transferring the digital work, access the digital work, recovering the digital work, etc.

In some embodiments, blocks may contain rules and data for authorizing different types of actions and/or parties who can take action. In some embodiments, transaction and block forming rules may be part of the software algorithm on each node. When a new block is being formed, any node on the system can use the prior records in the blockchain to verify whether the requested action is authorized. For example, a block may contain a public key of an owner of a digital work that allows the owner to show possession and/or transfer the digital work using a private key. Nodes may verify that the owner is in possession of the digital work and/or is authorized to transfer the digital work based on prior transaction records when a block containing the transaction is being formed and/or verified. In some embodiments, rules themselves may be stored in the blockchain such that the rules are also resistant to tampering once created and hashed into a block.

Now referring to FIG. 3, an illustration of blockchain based transactions according to some embodiments is shown. In some embodiments, the blockchain illustrated in FIG. 3 comprises a hash chain protected by private/public key encryption. Transaction A 310 represents a transaction recorded in a block of a blockchain showing that owner 1 (recipient) obtained a copy of a digital work from owner 0 (sender). Transaction A 310 contains owner's 1 public key and owner 0's signature for the transaction and a hash of a previous block. When owner 1 transfers the digital work to owner 2, a block containing transaction B 320 is formed. The record of transaction B 320 comprises the public key of owner 2 (recipient), a hash of the previous block, and owner 1's signature for the transaction that is signed with the owner 1's private key 325 and verified using owner 1's public key in transaction A 310. When owner 2 transfers the digital work to owner 3, a block containing transaction C 330 is formed. The record of transaction C 330 comprises the public key of owner 3 (recipient), a hash of the previous block, and owner 2's signature for the transaction that is signed by owner 2's private key 335 and verified using owner 2's public key from transaction B 220. In some embodiments, when each transaction record is created, the system may check previous transaction records and the current owner's private and public key signature to determine whether the transaction is valid. In some embodiments, transactions are be broadcasted in the peer-to-peer network and each node on the system may verify that the transaction is valid prior to adding the block containing the transaction to their copy of the blockchain. In some embodiments, nodes in the system may look for the longest chain in the system to determine the most up-to-date transaction record to prevent the current owner from double spending the asset. The transactions in FIG. 3 are shown as an example only. In some embodiments, a blockchain record and/or the software algorithm may comprise any type of rules that regulate who and how the chain may be extended. In some embodiments, the rules in a blockchain may comprise clauses of a smart contract that is enforced by the peer-to-peer network.

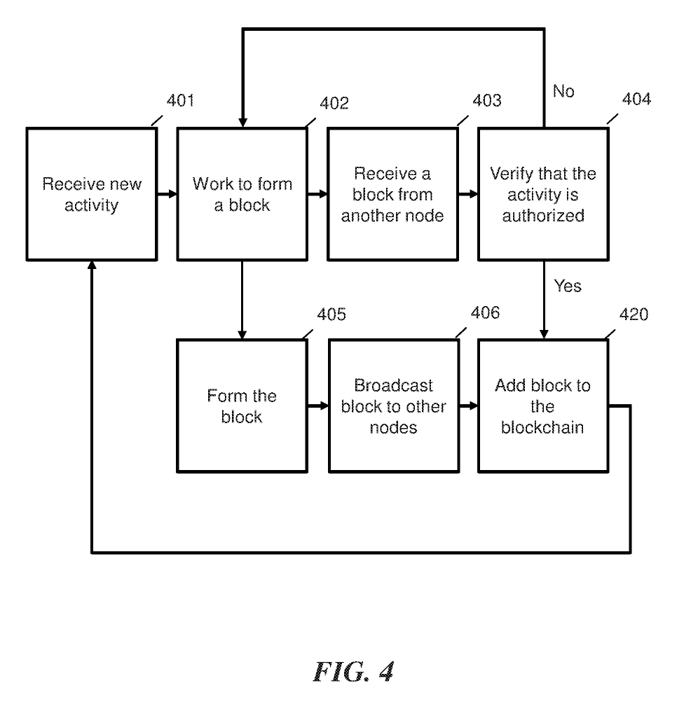

Now referring to FIG. 4, a flow diagram according to some embodiments is shown. In some embodiments, the steps shown in FIG. 4 may be performed by a processor-based device, such as a computer system, a server, a distributed server, a timestamp server, a blockchain node, and the like. In some embodiments, the steps in FIG. 4 may be performed by one or more of the nodes in a system using blockchain for record keeping, for example, the user terminal devices.

In step 401, a node receives a new activity in response to the authentication of the user terminal devices. The new activity may comprise an update to the record being kept in the form of a blockchain. In some embodiments, for blockchain supported digital or physical record keeping, the new activity can correspond to the authentication of the user terminal devices and/or the activities to the digital work according to the request generated at the user terminal device. In some embodiments, the new activity may be broadcasted to a plurality of nodes on the network prior to step 401. In step 402, the node works to form a block to update the blockchain. In some embodiments, a block may comprise a plurality of activities or updates and a hash of one or more previous block in the blockchain. In some embodiments, the system may comprise consensus rules for individual transactions and/or blocks and the node may work to form a block that conforms to the consensus rules of the system. In some embodiments, the consensus rules may be specified in the software program running on the node. For example, a node may be required to provide a proof standard (e.g. proof of work, proof of stake, etc.) which requires the node to solve a difficult mathematical problem for form a nonce in order to form a block. In some embodiments, the node may be configured to verify that the activity is authorized prior to working to form the block. In some embodiments, whether the activity is authorized may be determined based on records in the earlier blocks of the blockchain itself.

After step 402, if the node successfully forms a block in step 405 prior to receiving a block from another node, the node broadcasts the block to other nodes over the network in step 406. In step 420, the node then adds the block to its copy of the blockchain. In the event that the node receives a block formed by another node in step 403 prior to being able to form the block, the node works to verify that the activity (e.g., authentication of activities to the digital work) recorded in the received block is authorized in step 404. In some embodiments, the node may further check the new block against system consensus rules for blocks and activities to verify whether the block is properly formed. If the new block is not authorized, the node may reject the block update and return to step 402 to continue to work to form the block. If the new block is verified by the node, the node may express its approval by adding the received block to its copy of the blockchain in step 420. After a block is added, the node then returns to step 401 to form the next block using the newly extended blockchain for the hash in the new block.

In some embodiments, in the event one or more blocks having the same block number is received after step 420, the node may verify the later arriving blocks and temporarily store these block if they pass verification. When a subsequent block is received from another node, the node may then use the subsequent block to determine which of the plurality of received blocks is the correct/consensus block for the blockchain system on the distributed database and update its copy of the blockchain accordingly. In some embodiments, if a node goes offline for a time period, the node may retrieve the longest chain in the distributed system, verify each new block added since it has been offline, and update its local copy of the blockchain prior to proceeding to step 401.

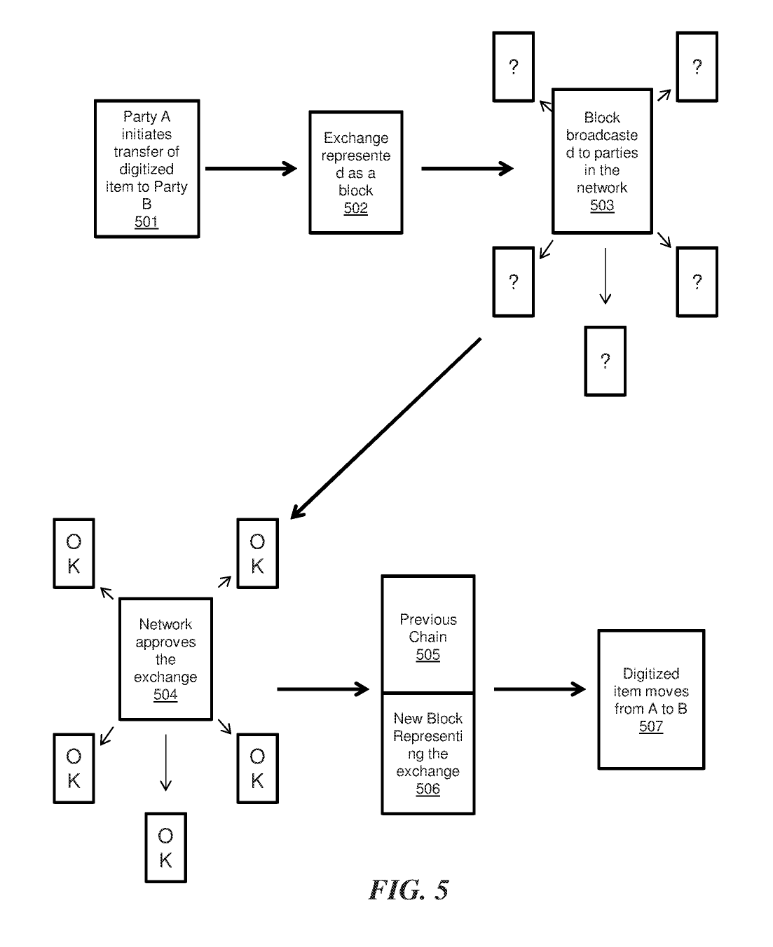

Now referring to FIG. 5, a process diagram a blockchain update according to some implementations in shown. In step 501, party A initiates the transfer of a digital work to party B. In some embodiments, Party A may prove that he has possession of the digital work by signing the transaction with a private key that may be verified with a public key in the previous transaction of the digital work. In step 502, the exchange initiated in step 501 is represented as a block. In some embodiments, the transaction may be compared with transaction records in the longest chain in the distributed system to verify part A's ownership. In some embodiments, a plurality of nodes in the network may compete to form the block containing the transaction record. In some embodiments, nodes may be required to satisfy proof-of-work by solving a difficult mathematical problem to form the block. In some embodiments, other methods of proof such as proof-of-stake, proof-of-space, etc. may be used in the system. In some embodiments, a block may represent one or more transactions between different parties that are broadcasted to the nodes. In step 503, the block is broadcasted to parties in the network. In step 504, nodes in the network approve the exchange by examining the block that contains the exchange. In some embodiments, the nodes may check the solution provided as proof-of-work to approve the block. In some embodiments, the nodes may check the transaction against the transaction record in the longest blockchain in the system to verify that the transaction is valid (e.g. party A is in possession of the asset he/she s seeks to transfer). In some embodiments, a block may be approved with consensus of the nodes in the network. After a block is approved, the new block 506 representing the exchange is added to the existing chain 505 comprising blocks that chronologically precede the new block 506. The new block 506 may contain the transaction(s) and a hash of one or more blocks in the existing chain 505. In some embodiments, each node may then update their copy of the blockchain with the new block and continue to work on extending the chain with additional transactions. In step 507, when the chain is updated with the new block, the digital work is moved from party A to party B.

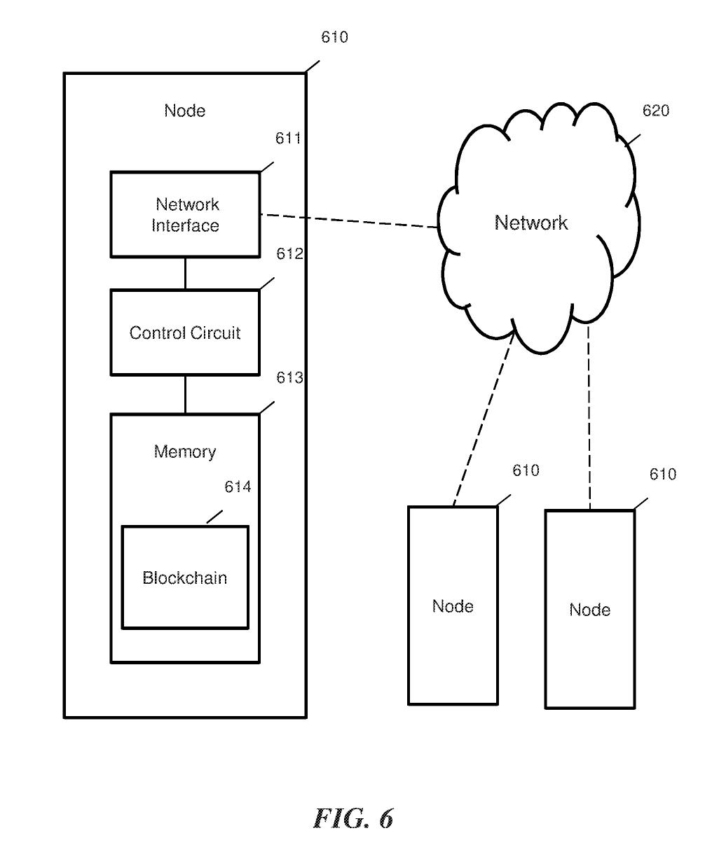

Now referring to FIG. 6, a system according to some embodiments is shown. A distributed blockchain system comprises a plurality of nodes 610 communicating over a network 620. In some embodiments, the nodes 610 may be comprise a distributed blockchain server and/or a distributed timestamp server. Each node 610 in the system comprises a network interface 611, a control circuit 612, and a memory 613.

The control circuit 612 may comprise a processor, a microprocessor, and the like and may be configured to execute computer readable instructions stored on a computer readable storage memory 613. The computer readable storage memory may comprise volatile and/or non-volatile memory and have stored upon it a set of computer readable instructions which, when executed by the control circuit 612, causes the node 610 update the blockchain 614 stored in the memory 613 based on communications with other nodes 610 over the network 620. In some embodiments, the control circuit 612 may further be configured to extend the blockchain 614 by processing updates to form new blocks for the blockchain 614. Generally, each node may store a version of the blockchain 614, and together, may form a distributed database. In some embodiments, each node 610 may be configured to perform one or more steps described with reference to FIGS. 4-5 herein.

The network interface 611 may comprise one or more network devices configured to allow the control circuit to receive and transmit information via the network 620. In some embodiments, the network interface 611 may comprise one or more of a network adapter, a modem, a router, a data port, a transceiver, and the like. The network 620 may comprise a communication network configured to allow one or more nodes 610 to exchange data. In some embodiments, the network 620 may comprise one or more of the Internet, a local area network, a private network, a virtual private network, a home network, a wired network, a wireless network, and the like. In some embodiments, the system does not include a central server and/or a trusted third party system. Each node in the system may enter and leave the network at any time.

With the system and processes shown in, once a block is formed, the block cannot be changed without redoing the work to satisfy census rules thereby securing the block from tampering. A malicious attacker would need to provide proof standard for each block subsequent to the one he/she seeks to modify, race all other nodes, and overtake the majority of the system to affect change to an earlier record in the blockchain.

The blockchain system can use a peer-to-peer distributed timestamp server to generate computational proof of the chronological order of transactions. Generally, the blockchain system is secure as long as honest nodes collectively control more processing power than any cooperating group of attacker nodes. With a blockchain, the transaction records are computationally impractical to reverse. As such, owners of digital works are protected from fraud.

In some embodiments, in the peer-to-peer network, the longest chain proves the sequence of events witnessed, proves that it came from the largest pool of processing power, and that the integrity of the document has been maintained. In some embodiments, the network for supporting blockchain based record keeping requires minimal structure. In some embodiments, messages for updating the record are broadcast on a best-effort basis. Nodes can leave and rejoin the network at will and may be configured to accept the longest proof-of-work chain as proof of what happened while they were away.

In some embodiments, the blockchain may be used to ensure that a digital work was not altered after a given timestamp, that alterations made can be followed to a traceable point of origin, that only people with authorized keys can access the digital work, that the digital work itself is the original and cannot be duplicated, that where duplication is allowed and the integrity of the copy is maintained along with the original, that the creator of the digital work was authorized to create the document, and/or that the holder of the digital work was authorized to transfer, alter, or otherwise act on the document.

As used herein, in some embodiments, the term blockchain may refer to one or more of a hash chain, a hash tree, a distributed database, and a distributed ledger. In some embodiments, blockchain may further refer to systems that uses one or more of cryptography, private/public key encryption, proof standard, distributed timestamp server, and inventive schemes to regulate how new blocks may be added to the chain.

Descriptions of embodiments of blockchain technology are provided herein as illustrations and examples only. The concepts of the blockchain system may be variously modified and adapted for different applications.

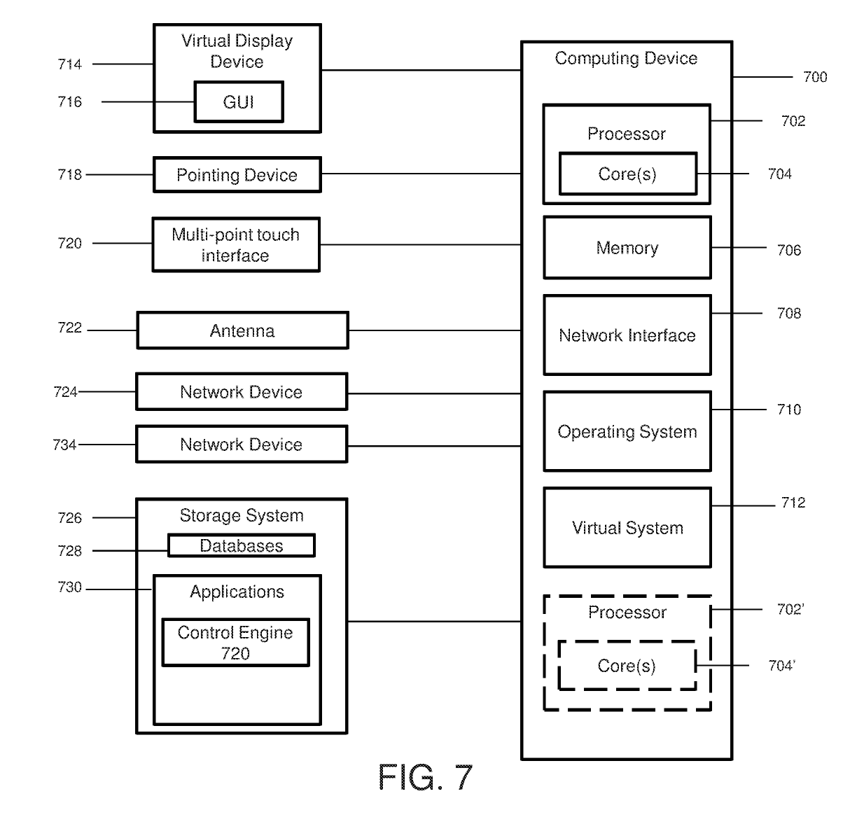

FIG. 7 is a block diagram of an example computing device for implementing exemplary embodiments of the present disclosure. Embodiments of the computing device 700 can implement embodiments of the blockchain ownership storage system. The computing device 700 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 706 included in the computing device 700 may store computer-readable and computer-executable instructions or software (e.g., applications 730 such as the control engine 720) for implementing exemplary operations of the computing device 700. The computing device 700 also includes configurable and/or programmable processor 702 and associated core(s) 704, and optionally, one or more additional configurable and/or programmable processor(s) 702′ and associated core(s) 704′ (for example, in the case of computer systems having multiple processors/cores), for executing computer-readable and computer-executable instructions or software stored in the memory 706 and other programs for implementing exemplary embodiments of the present disclosure. Processor 702 and processor(s) 702′ may each be a single core processor or multiple core (704 and 704′) processor. Either or both of processor 702 and processor(s) 702′ may be configured to execute one or more of the instructions described in connection with computing device 700.

Virtualization may be employed in the computing device 700 so that infrastructure and resources in the computing device 700 may be shared dynamically. A virtual machine 712 may be provided to handle a process running on multiple processors so that the process appears to be using only one computing resource rather than multiple computing resources. Multiple virtual machines may also be used with one processor.

Memory 706 may include a computer system memory or random access memory, such as DRAM, SRAM, EDO RAM, and the like. Memory 706 may include other types of memory as well, or combinations thereof. The computing device 700 can receive data from input/output devices such as, an image capturing device 734. The image capturing device 734 can capture still or moving images. A user may interact with the computing device 700 through a visual display device 714, such as a computer monitor, which may display one or more graphical user interfaces 716, multi touch interface 720 and a pointing device 718.

The computing device 700 may also include one or more storage devices 726, such as a hard-drive, CD-ROM, or other computer readable media, for storing data and computer-readable instructions and/or software that implement exemplary embodiments of the present disclosure (e.g., applications such as the control engine 720). For example, exemplary storage device 726 can include one or more databases 728 for storing information associated with representations of digital IP work and ownership associated with the representations of the digital IP work. The databases 728 may be updated manually or automatically at any suitable time to add, delete, and/or update one or more data items in the databases.

The computing device 700 can include a network interface 708 configured to interface via one or more network devices 724 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 722 to facilitate wireless communication (e.g., via the network interface) between the computing device 700 and a network and/or between the computing device 700 and other computing devices. The network interface 708 may include a built-in network adapter, network interface card, PCMCIA network card, card bus network adapter, wireless network adapter, USB network adapter, modem or any other device suitable for interfacing the computing device 700 to any type of network capable of communication and performing the operations described herein.

The computing device 700 may run any operating system 710, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 700 and performing the operations described herein. In exemplary embodiments, the operating system 710 may be run in native mode or emulated mode. In an exemplary embodiment, the operating system 710 may be run on one or more cloud machine instances.

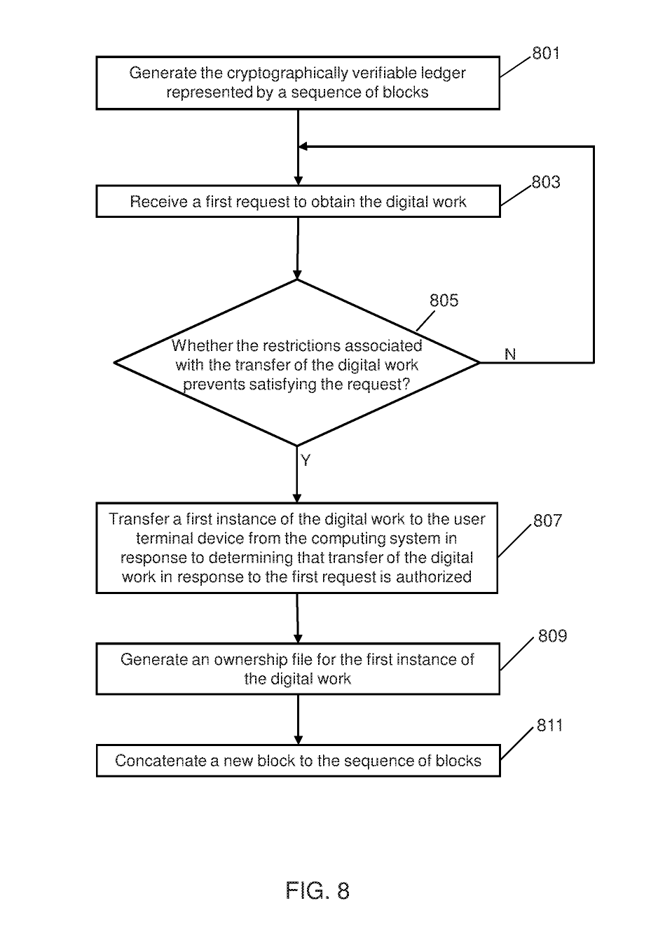

FIG. 8 is a flowchart illustrating the blockchain ownership storage system. At step 801 the system generates the cryptographically verifiable ledger represented by a sequence of blocks. Each block contains one or more transactions records and each subsequent block contains a hash value associated with the previous block, and at least one of the blocks contains transaction records associated with ownership a digital work, and the blocks that contains transaction records associated with ownership of the digital work includes restrictions associated with transfers of the digital work. After the system receives a first request, from the at least one user terminal device, to obtain the digital work at step 803, the system determines whether the restrictions associated with the transfer of the digital work prevents satisfying the request at step 805. When it is determined that transfer of the digital work in response to the first request is not authorized, the process goes back to step 803 where the system receives another request to obtain the digital work.

When it is determined that transfer of the digital work in response to the first request is authorized, the system transfers a first instance of the digital work to the user terminal device at step 807. Then an ownership file for the first instance of the digital work is generated at step 809, and a new block is concatenated to the sequence of blocks at step 811. The new block includes the ownership file and new restrictions associated with transfer of the first instance of the digital work.

In accordance with embodiments of the present disclosure, the system further updates to add additional blocks to the sequence of blocks in response to user actions associated with the first instance of the digital work transferred to the user terminal device.

In accordance with embodiments of the present disclosure, the system can terminates user access to the digital work in response to detecting the updated sequence of blocks indicating a user action including specified usage patterns, such as fraudulence actions. In some embodiment, the digital work can be stored in a database and the blockchain can be used by the system to control access to the digital work. For example, the digital work can have a set of permissions associated with it, e.g., read, write, modify, etc. In response to a user's actions associated with the ownership records in the blockchain, e.g., an authenticated request or an unauthenticated request for access, those permissions can be automatically changed by the system, e.g., to permit access to the digital work or terminate the digital work, according to the authenticated request or the unauthenticated request, respectively. For example, the system can automatically changes the permissions to close digital work if it detects usage patterns that indicate stealing, such as copying to personal drives or screen stops that indicate the user might be taking photographs, or extremely slow scrolling that indicates someone might be physically typing IP onto another device. In another example, blockchain uses patterns that indicate theft to trigger a temporary shutdown to all accesses on the associated user ID or system wide until the theft action is cleared.

In accordance with embodiments of the present disclosure, when the system receives a request from the user for recovering the first instance of the digital work, the system can transfer a second instance of the digital work to the user terminal device or a different user terminal device. The second instance of the digital work is associated with at least one of the additional blocks in the updated sequence of blocks.

In accordance with embodiments of the present disclosure, the system may terminate user access to the first instance of the digital work in response to detecting the updated sequence of blocks indicating a user action associated with the first instance of the digital work after a second instance of the digital work is transferred to the user terminal device or the different user terminal device. For example, digital content companies maintain existing practices that make it easy for people to recover loses, for example, receipts of purchased books that could then be duplicated for the buyer. However, when the seller receives blockchain updates that indicate a user sold his or her copy on the secondary market and that the lost digital IP is not actually lost, the system can prevent the user from accessing or terminate the user access to the duplicated copy of the digital work.

In accordance with embodiments of the present disclosure, in response to detecting an updated sequence of blocks indicating a user action of transferring the first instance of the digital work from a first user to a second user, a specified activity between the second user and an owner of the digital work is triggered. For example, when the digital work is transferred from one owner to another owner without duplicating, the transfer may trigger commercial activity, for example, a royalty payments to the artist who created the digital work.

In accordance with embodiments of the present disclosure, subsequent transferring of the digital work is not restricted when an owner of the digital work modifies the at least one of the blocks or the new block that contains transaction records associated with the ownership file. For example, the artists can remove or add the associated blockchain for the digital IP work that they create, if they want their digital IP work to be shared free, or not shared.

In some embodiments, to remove unnecessary actions, the system can determine whether the digital work automatically receives blockchain code or not based on the user settings.

In some embodiments, blockchain event is triggered to the degree necessary from digital work transfer to any time the digital work is accessed.

In some embodiments, the user keys are placed safely apart. The user keys could be physical handshake devices so that the key is never stored on the same device that has the digital work.

In some embodiments, digital work, such as consumer content, can have one duplicate at the source of origin that allows for disaster recovery if the consumer content is destroyed.

In some embodiments, blockchain maintains digital work integrity and also encodes the who, what, when, where, why, and how, to the extent possible in digital code, on document access,

In another embodiments, hashtag key changes are transparent to legitimate users and are themselves blockchained so that each key is digital work that cannot be duplicated.

In some embodiments, the system can includes blockchain layering whereby blockchain elements are themselves blockchained as individual units.

In some embodiments, Emails can be digital IP transfers of value that require an exchange of hashtag keys for a receiver on the other end to open and read the email.

In some embodiments, the user can self-trigger added blockchain code even if no other transfer or action takes place.

In some embodiments, the digital work owners with permission can curtail blockchain so that content can be copied and shared.

In another embodiments, the digital work owners can allow sharing, for example, by allowing all friends on a social media account to access and share photographs, but not allow the photographs to be shared beyond that point.

In some embodiments, blockchain software can be combined to plagiarism software so that documents that are created by cut and paste within the system or the accessing device are immediately flagged as “plagiarisms” and locked.

In some embodiments, digital work can be accessed and reviewed by multiple people within the system, though only the earliest accessor at the moment can make changes. Alternatively, only the individual owner can make changes, for example, the author of the digital work.

In some embodiments, assisting element can be inserted into blockchain. For example, blockchain could be combined with readable text that indicates digital work status, for example, “Song Title—John Smith's copy” or “user identity X copy.”

In some embodiments, the hashtag key could require other security elements to work, for example, fingerprint, eye scans, voice patterns, passcodes, or passwords.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. A secure storage system for maintaining ownership rights of digital works, the system comprising:
one or more non-transitory computer-readable media configured to store a cryptographically verifiable ledger represented by a sequence of blocks;
a computing system in communication with at least one user terminal device and the one or more non-transitory computer-readable media, the computing system configured to:
generate the cryptographically verifiable ledger represented by a sequence of blocks in the one or more computer-readable media, each block containing one or more transactions records and each subsequent block containing a hash value associated with the previous block, wherein at least one of the blocks contains transaction records associated with ownership a digital work, and wherein the at least one of the blocks that contains transaction records associated with ownership of the digital work includes restrictions associated with transfers of the digital work;
receive a first request, from the at least one user terminal device, to obtain the digital work;
determine whether the restrictions associated with the transfer of the digital work prevents satisfying the request;
transfer a first instance of the digital work to the at least one user terminal device from the computing system in response to determining that transfer of the digital work in response to the first request is authorized;
generate an ownership file for the first instance of the digital work; and
concatenate a new block to the sequence of blocks, the new block including the ownership file and new restrictions associated with transfer of the first instance of the digital work.

2. The system of claim 1, wherein the computing system is configured to:
update to add additional blocks to the sequence of blocks in response to user actions associated with the first instance of the digital work transferred to the user terminal device.

3. The system of claim 2, wherein the computing system is configured to:
terminate user access to the digital work in response to detecting the updated sequence of blocks indicating a user action including specified usage patterns.

4. The system of claim 2, wherein the computing system is configured to:
transfer a second instance of the digital work to the at least one user terminal device or a different user terminal device in response to receiving a second request for recovering the first instance of the digital work, and
wherein the second instance of the digital work is associated with at least one of the additional blocks in the updated sequence of blocks.

5. The system of claim 4, wherein the computing system is configured to:
terminate user access to the first instance of the digital work in response to detecting the updated sequence of blocks indicating a user action associated with the first instance of the digital work after the second instance of the digital work is transferred to the at least one user terminal device or the different user terminal device.

6. The system of claim 1, wherein the computing system is configured to:
in response to detecting an updated sequence of blocks indicating a user action of transferring the first instance of the digital work from a first user to a second user, trigger a specified activity between the second user and an owner of the digital work.

7. The system of claim 1, wherein subsequent transferring of the digital work is not restricted when an owner of the digital work modifies the at least one of the blocks or the new block that contains transaction records associated with the ownership file.

8. A method for communicating with a secure storage system for maintaining ownership rights of digital works, the method comprising:
generating a cryptographically verifiable ledger represented by a sequence of blocks that is stored in one or more non-transitory computer-readable media, each block containing one or more transactions records and each subsequent block containing a hash value associated with the previous block, wherein at least one of the blocks contains transaction records associated with ownership a digital work, and wherein the at least one of the blocks that contains transaction records associated with ownership of the digital work includes restrictions associated with transfers of the digital work;
receiving a first request, from at least one user terminal device, to obtain the digital work;
determining whether the restrictions associated with the transfer of the digital work prevents satisfying the request;
transferring a first instance of the digital work to the at least one user terminal device in response to determining that transfer of the digital work in response to the first request is authorized;
generating an ownership file for the first instance of the digital work; and
concatenating a new block to the sequence of blocks, the new block including the ownership file and new restrictions associated with transfer of the first instance of the digital work.

9. The method of claim 8, further comprising:
updating to add additional blocks to the sequence of blocks in response to user actions associated with the first instance of the digital work transferred to the user terminal device.

10. The method of claim 9, further comprising:
terminating user access to the digital work in response to detecting the updated sequence of blocks indicating a user action including specified usage patterns.

11. The method of claim 9, further comprising:
transferring a second instance of the digital work to the at least one user terminal device or a different user terminal device in response to receiving a second request for recovering the first instance of the digital work, and
wherein the second instance of the digital work is associated with at least one of the additional blocks in the updated sequence of blocks.

12. The method of claim 11, further comprising:
terminating user access to the first instance of the digital work in response to detecting the updated sequence of blocks indicating a user action associated with the first instance of the digital work after the second instance of the digital work is transferred to the at least one user terminal device or the different user terminal device.

13. The method of claim 8, further comprising:
in response to detecting an updated sequence of blocks indicating a user action of transferring the first instance of the digital work from a first user to a second user, triggering a specified activity between the second user and an owner of the digital work.

14. The method of claim 8, wherein subsequent transferring of the digital work is not restricted when an owner of the digital work modifies the at least one of the blocks or the new block that contains transaction records associated with the ownership file.

15. A non-transitory computer-readable medium storing instructions that are executable by a processing device, wherein execution of the instructions by the processing device causes the processing device to:
generate a cryptographically verifiable ledger represented by a sequence of blocks that is stored in one or more non-transitory computer-readable media, each block containing one or more transactions records and each subsequent block containing a hash value associated with the previous block, wherein at least one of the blocks contains transaction records associated with ownership a digital work, and wherein the at least one of the blocks that contains transaction records associated with ownership of the digital work includes restrictions associated with transfers of the digital work;
receive a first request, from at least one user terminal device, to obtain the digital work;
determine whether the restrictions associated with the transfer of the digital work prevents satisfying the request;
transfer a first instance of the digital work to the at least one user terminal device from the computing system in response to determining that transfer of the digital work in response to the first request is authorized;
generate an ownership file for the first instance of the digital work; and
concatenate a new block to the sequence of blocks, the new block including the ownership file and new restrictions associated with transfer of the first instance of the digital work.

16. The non-transitory computer-readable medium of claim 15, wherein execution of the instructions by the processing device causes the processing device to:
update to add additional blocks to the sequence of blocks in response to user actions associated with the first instance of the digital work transferred to the user terminal device.

17. The non-transitory computer-readable medium of claim 16, wherein execution of the instructions by the processing device causes the processing device to:
terminate user access to the digital work in response to detecting the updated sequence of blocks indicating a user action including specified usage patterns.

18. The non-transitory computer-readable medium of claim 16, wherein execution of the instructions by the processing device causes the processing device to:
transfer a second instance of the digital work to the at least one user terminal device or a different user terminal device in response to receiving a second request for recovering the first instance of the digital work, and
wherein the second instance of the digital work is associated with at least one of the additional blocks in the updated sequence of blocks.

19. The non-transitory computer-readable medium of claim 18, wherein execution of the instructions by the processing device causes the processing device to:
terminate user access to the first instance of the digital work in response to detecting the updated sequence of blocks indicating a user action associated with the first instance of the digital work after the second instance of the digital work is transferred to the at least one user terminal device or the different user terminal device.

20. The non-transitory computer-readable medium of claim 15, wherein execution of the instructions by the processing device causes the processing device to:
in response to detecting an updated sequence of blocks indicating a user action of transferring the first instance of the digital work from a first user to a second user, trigger a specified activity between the second user and an owner of the digital work.

21. The non-transitory computer-readable medium of claim 15, wherein subsequent transferring of the digital work is not restricted when an owner of the digital work modifies the at least one of the blocks or the new block that contains transaction records associated with the ownership file.
